(19) United States
(12) Patent Application Publication
(10) Pub. No.: US 2013/0041894 A1
(43) Pub. Date: Feb. 14, 2013

(54) Mitigating Environment, Health, and Safety Complications

(71) Applicants: Kathleen A. DiZio, Livermore, CA (US); John A. Fitzsimmons, Poughkeepsie, NY (US); Richard J. Melville, Newburgh, NY (US); David E. Speed, Newtown, CT (US); Ernest L. Timlin, JR., Poughkeepsie, NY (US); Connie-Nga T. Truong, Poughkeepsie, NY (US)

(72) Inventors: Kathleen A. DiZio, Livermore, CA (US); John A. Fitzsimmons, Poughkeepsie, NY (US); Richard J. Melville, Newburgh, NY (US); David E. Speed, Newtown, CT (US); Ernest L. Timlin, JR., Poughkeepsie, NY (US); Connie-Nga T. Truong, Poughkeepsie, NY (US)

(73) Assignee: INTERNATIONAL BUSINESS MACHINES CORPORATION, Armonk, NY (US)

(21) Appl. No.: 13/206,546

(22) Filed: Aug. 10, 2011

(51) Int. Cl. G06F 17/30

(52) U.S. Cl. 707/723; 707/E17.014

(57) ABSTRACT

A method of identifying a substitute chemical includes receiving, at a computer, a trial set of properties that describes a function in a desired chemical process of a chemical for substitution, performing a distributed search using objective similarity criteria based on the trial set of properties to identify a first set of candidate chemicals, prioritizing the first set of candidate chemicals into a second set of candidate chemicals, determining Environmental, Health, and Safety (EHS) data parameter values for each chemical of the second set of candidate chemicals, normalizing disparate EHS data parameter values into associated EHS properties, prioritizing the second set of candidate chemicals into a third set of candidate chemicals, and prioritizing the third set of candidate chemicals into a fourth set of candidate chemicals according to the risk posed by the desired chemical process.

### BACKGROUND

The present invention relates to chemical processes, and more specifically, to mitigating environment, health, and safety (EHS) issues which may arise from conventional chemical processes.

As technology advances many research processes migrate to the manufacturing process space. While it is well understood that highly trained individuals are capable of understanding and handling many chemistries that have potentially significant EHS issues, it is often a challenge to handle these chemistries when they are introduced into the manufacturing workspace sphere where generalized training and understanding of EHS hazards may not be as common as in the research environment.

### SUMMARY

According to one embodiment of the present invention, a method of identifying a substitute chemical includes receiving, at a computer, a trial set of properties including physicochemical properties or molecular attributes that describes a function in a desired chemical process of a given chemical targeted for substitution, performing a distributed multiple database search using objective similarity criteria based on the trial set of properties to identify a first set of candidate chemicals with physicochemical properties or molecular attributes related to the trial set of properties, prioritizing the first set of candidate chemicals into a second set of candidate chemicals based on an efficacy of each chemical for the desired chemical process application, determining Environmental, Health, and Safety (EHS) data parameter values for each chemical of the second set of candidate chemicals, normalizing disparate EHS data parameter values into associated EHS properties for each chemical of the second set of candidate chemicals, prioritizing the second set of candidate chemicals into a third set of candidate chemicals according to the associated EHS properties to identify the least hazardous candidate chemicals, and prioritizing the third set of candidate chemicals into a fourth set of candidate chemicals according to the risk posed by the desired chemical process.

According to one embodiment of the present invention, a system for identifying a substitute chemical includes a plurality of chemical databases, wherein each chemical database is configured to store information related to the molecular and physical properties of a plurality of chemicals, and a computer apparatus in operative communication with the plurality of chemical databases, wherein the computer apparatus is configured to execute computer executable instruction that direct the computer apparatus to perform a method. The method includes receiving, at the computer, a set of chemical properties of a chemical to be replaced, identifying candidate substitute chemicals within the plurality of chemical databases based upon similarities between the set of chemical properties and chemical properties of each candidate substitute chemical considered, evaluating environmental impact characteristics and human health impact characteristics of the candidate substitute chemicals, prioritizing the candidate replacement chemicals based on the environmental impact characteristics and the human health impact characteristics of each candidate replacement chemical, and determining if an appropriate replacement chemical exists within the prioritized candidate replacement chemicals.

According to one embodiment of the present invention, a computer program product includes a non-transitory computer readable storage medium having computer-executable instructions stored thereon that, when executed by a processor of a computer apparatus, direct the processor to perform a method. The method includes eceiving, at a computer, a trial set of properties including physicochemical properties or molecular attributes that describes a function in a desired chemical process of a given chemical targeted for substitution, performing a distributed multiple database search using objective similarity criteria based on the trial set of properties to identify a first set of candidate chemicals with physicochemical properties or molecular attributes related to the trial set of properties, prioritizing the first set of candidate chemicals into a second set of candidate chemicals based on an efficacy of each chemical for the desired chemical process application, determining Environmental, Health, and Safety (EHS) data parameter values for each chemical of the second set of candidate chemicals, normalizing disparate EHS data parameter values into associated EHS properties for each chemical of the second set of candidate chemicals, prioritizing the second set of candidate chemicals into a third set of candidate chemicals according to the associated EHS properties to identify the least hazardous candidate chemicals, and prioritizing the third set of candidate chemicals into a fourth set of candidate chemicals according to the risk posed by the desired chemical process.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a method of weighing environment, health, and safety issues in a chemical process, according to an example embodiment;

FIG. 2 illustrates a method of mitigating environment, health, and safety issues in a chemical process, according to an example embodiment;

FIG. 3 illustrates a method of estimating the reliability of a chemical substitute configured to mitigate environment, health, and safety issues in a chemical process, according to an example embodiment; and

FIG. 4 illustrates a computing environment configured to mitigate the environment, health, and safety issues in a chemical process, according to an example embodiment.

### DETAILED DESCRIPTION

Example embodiments of the present invention provide a formalized review methodology to determine process hazards as well as methods to determine if alternative chemical process formulations may decrease the EHS impact of a chemical process.

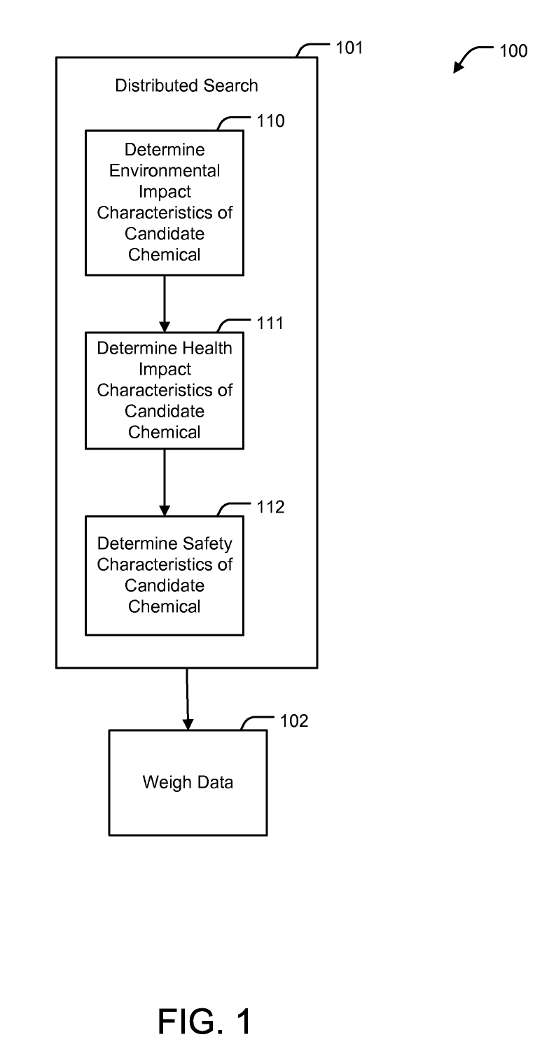

Turning to FIG. 1, a method of weighing environment, health, and safety issues in a chemical process is illustrated. The method 100 may include performing a distributed search for attributes of a candidate chemical at block 101 and appropriately weighing the results of the search at block 102 to determine possible EHS issues.

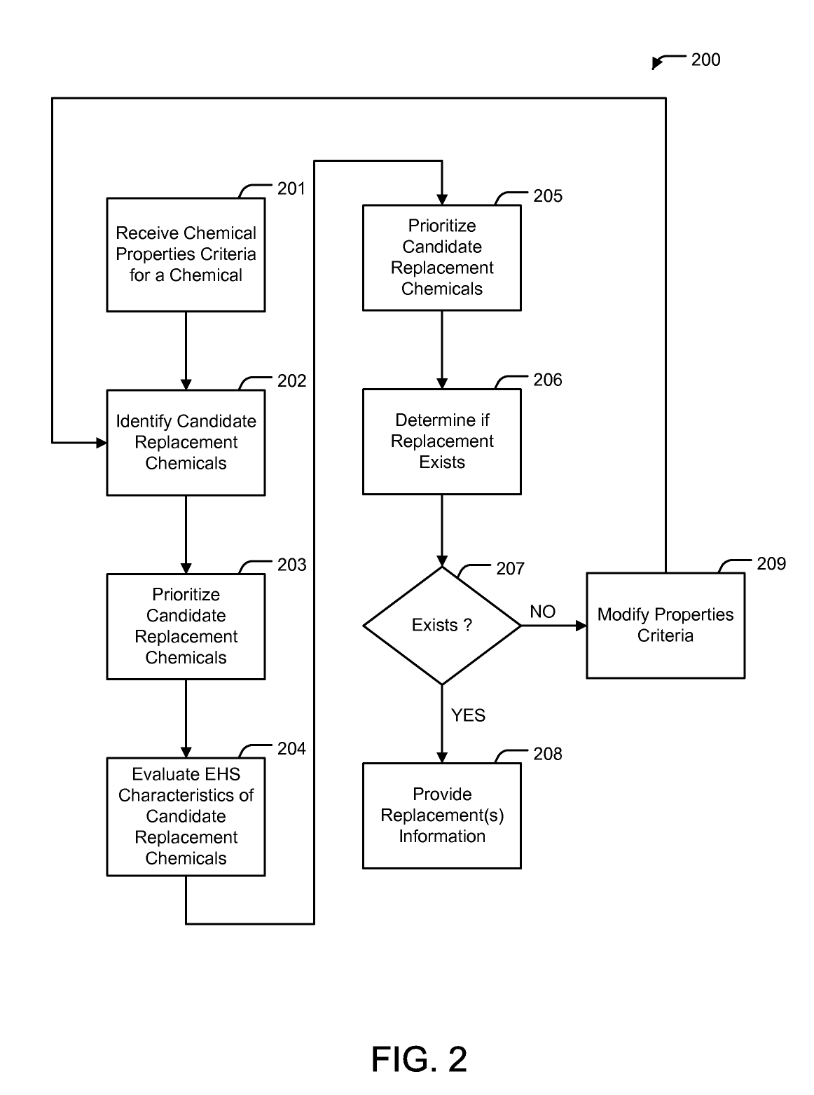

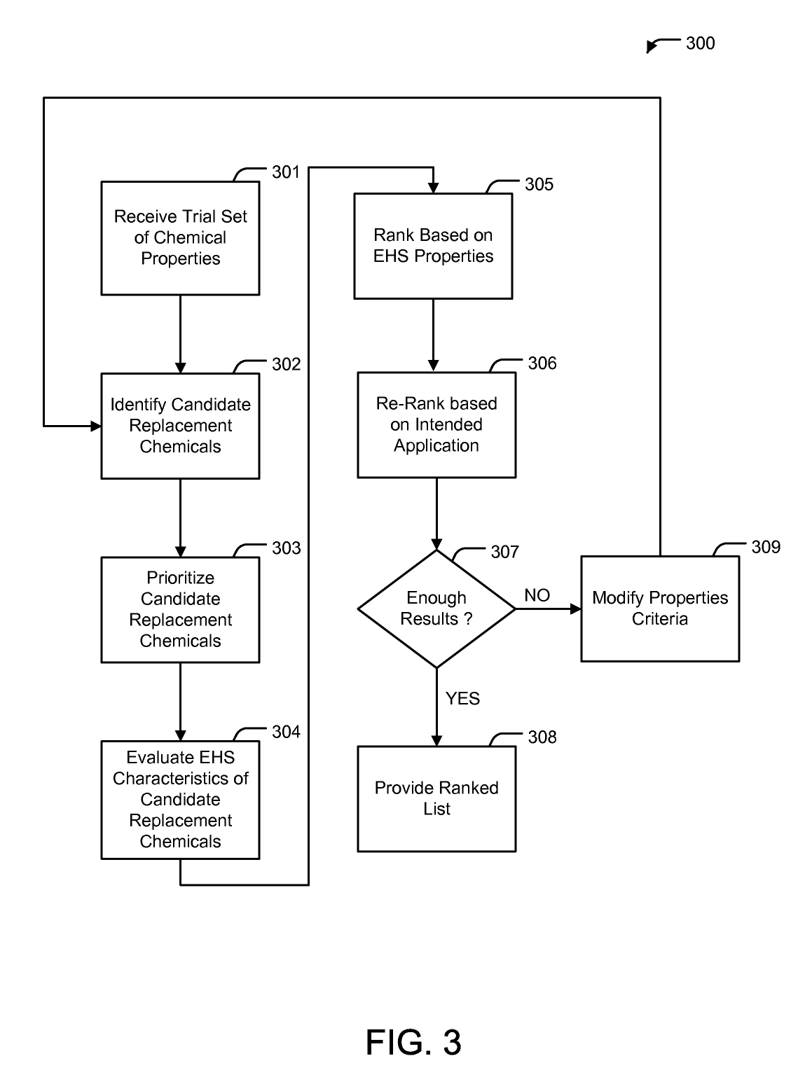

The distributed search includes evaluation of the impact of the candidate chemical with regards to characteristics of the chemical interacting with the environment and personnel. These characteristics are weighed to gauge an overall impact or risk of utilizing the candidate chemical; and using the methods described in FIGS. 2-3, to determine possible substitute chemicals which mitigate these impacts/risks.

Turning back to FIG. 1, during the distributed search at block 101, the method 100 includes determining environmental impact characteristics of the candidate chemical at block 110. The environmental impact characteristics may include biodegradability, air-water partitioning, bioaccumulation potential and/or any other environmental behavior deemed appropriate for the distributed search. It is noted that given the broad nature of environmental interaction involved with any particular chemical, exhaustive description of every possible attribute is omitted herein for the sake of brevity.

The method further includes determining health impact characteristics of the candidate chemical at block 111. The health impact characteristics may include any potential impact of the chemical on a human body in contact or working with said chemical. For example, health impact characteristics may include toxicity, pharmacokinetics, route of exposure for adverse effects, and/or any health impact deemed appropriate for the distributed search.

The method further includes determining safety characteristics of the candidate chemical at block 112. The safety characteristics may be similar to both the environmental impact and health impact characteristics, and may be related to general safety in the work setting in which the chemical candidate is being used. For example, flammability and associated smoke inhalation and other similar attributes may be deemed appropriate for a given distributed search.

Turning to FIG. 2, a method of mitigating environment, health, and safety issues in a chemical process using a candidate chemical is illustrated. The method 200 includes receiving desired chemical properties criteria for a target chemical at block 201. The chemical properties include physicochemical parameters and/or molecular structure attributes which are believed to provide the target chemical with its efficacy for a particular application, and may involve several alternative input sets.

As an example, in order to determine an appropriate replacement candidate for Tetramethylammonium hydroxide (TMAH) that is utilized as a pH adjuster in a plating bath, the attributes of TMAH that most likely provide it with its efficacy for the given process should be identified. Further, it may be assumed as a working model that the potential candidates have similar attributes. Thus, appropriate chemical properties for a pH adjuster may include the presence of a hydroxyl group, pK_{b} value, limited volatility to reduce evaporation, limited reactivity, and other similar characteristics.

It is noted that as in the example given above for a plating bath, other chemical uses may have different characteristics deemed as important. Therefore no particular characteristics outlined herein should be construed as limiting.

Turning back to FIG. 2, the method 200 further includes identifying candidate replacement chemicals at block 202. The candidate replacement chemicals are identified through an automated and distributed search based upon whether the candidates possess combinations of physicochemical parameters that fall within similar ranges to the target chemical. Different forms of searches may be combined and/or performed in parallel or sequentially to increase the efficacy of the search, with the results of these searches being ranked and or subsequently prioritized (205).

According to an example embodiment, the distributed search includes searching a plurality of databases for chemicals with particular properties which lay within boundaries of a desired numerical range.

According to an example embodiment, the distributed search includes excluding search results which contain particular chemical elements or element-combinations.

According to an example embodiment, the distributed search includes excluding chemicals with particular properties which extend beyond a maximum numerical boundary and/or below a minimum numerical boundary.

According to an example embodiment, the distributed search includes excluding results which lack information about a particular chemical property. For example, chemicals which lack a database pH value may be automatically excluded, and or flagged to indicate the absence of a value for a desired search parameter.

According to an example embodiment, the distributed search includes identifying and/or ranking chemical results based upon the minimization or maximization of an objective function that provides a measure of the difference between the target values for each of the searched parameters, and the parameter values of candidate chemicals. For example, for each chemical in the database containing perspective candidate chemicals, an objective function may be calculated based upon the magnitude of the summed and weighted deviations between the targeted parameter value and the candidate chemical's parameter value.

There are a variety of manners in which objective functions can be formulated. A weighted least squares method is one of the most commonly used objective functions, but constitutes just one example of a variety of potential means of formulating an objective function.

For example, according to one example embodiment, for the j^{th} chemical candidate, an objective function value Oⱼ is computed based upon the weighted sum of squared deviations between the targeted value of each search parameter and the value of that parameter listed in a searched database providing the results. Equation 1, below is an example objective function.

$${O}_{j} ( β ) = {\sum }_{{i = 1}_{j = 1}}^{M , N} {{w}_{i} ( {β}_{i}^{o} - {β}_{i}^{j} )}^{2} \qquad Equation 1$$

In equation 1, i=the index for each of the 1 thru N search parameters; j=the index for each of the 1 thru M candidate chemicals in a given database; wᵢ=the weight assigned to the i^{th} parameter; βᵢ^{o}==the target value for the i^{th} parameter; βᵢ^{j}=the listed value for the i^{th} parameter for the j^{th} chemical in the database. Values of parameters will vary depending upon the particular units of measurement that are used in a given database, and one manifestation of the described process is to identify the units of measure and convert to a common system of measurement units.

The objective function provides a measure of the deviation between the desired characteristics of the candidate chemical and a particular candidate chemical.

Additionally, according to some example embodiments the distributed search includes searching for particular functional groups. For example, string search provides a means of identifying chemicals which contain selected functional groups. For instance, many available data bases contain chemical structure information in the Simplified Molecular Input Line System (SMILES) format. The SMILES format portrays a chemical structure in a 2D graphic format that is similar to conventional valence oriented picture used to describe molecules. Thus, directed string comparisons may be made to accurately identify functional groups within the distributed search.

Turning back to FIG. 2, the method 200 further includes prioritizing candidate replacement chemicals based on similarity to a target chemical. The prioritizing may include sorting the distributed search results into a prioritized list based upon predetermined or desirable properties. For example, a chemical may be known to work for a particular application. Thus, this chemical may be included in the prioritized chemical results. However, if a chemical is known not to work, it may be removed from the prioritized chemical results. Further, the prioritizing may be facilitated through chemical property ratings, weights, and weighted ratings.

The rating represents a rescaling of the numeric EHS parameter values, such that disparate parameter values can be transformed to a common ordinate scale. The weights represent a multiplier value that may account for the differing levels of importance that each of the parameters may have. For instance, highly important parameters (e.g., carcinogenic) are weighted more highly than undesirable attributes like odor. The weighted rating for a given parameter is equal to the product of the Rating and the Weight and is intended to express the magnitude of an EHS hazard that a given parameter may hold, on a common ordinate scale. Thus, regardless of the type of measurement, units of measurement, or relative importance of a particular measurement; a parameter with weighted rating which has a larger magnitude than another, is reflective of a higher overall hazard. In this scheme, the sum of the weighted ratings for the individual parameters for a given compound provides the overall rating for the compound. The overall rating that a material receives is intended to provide a common and consistent basis for comparing and ranking the safety level of the chemicals.

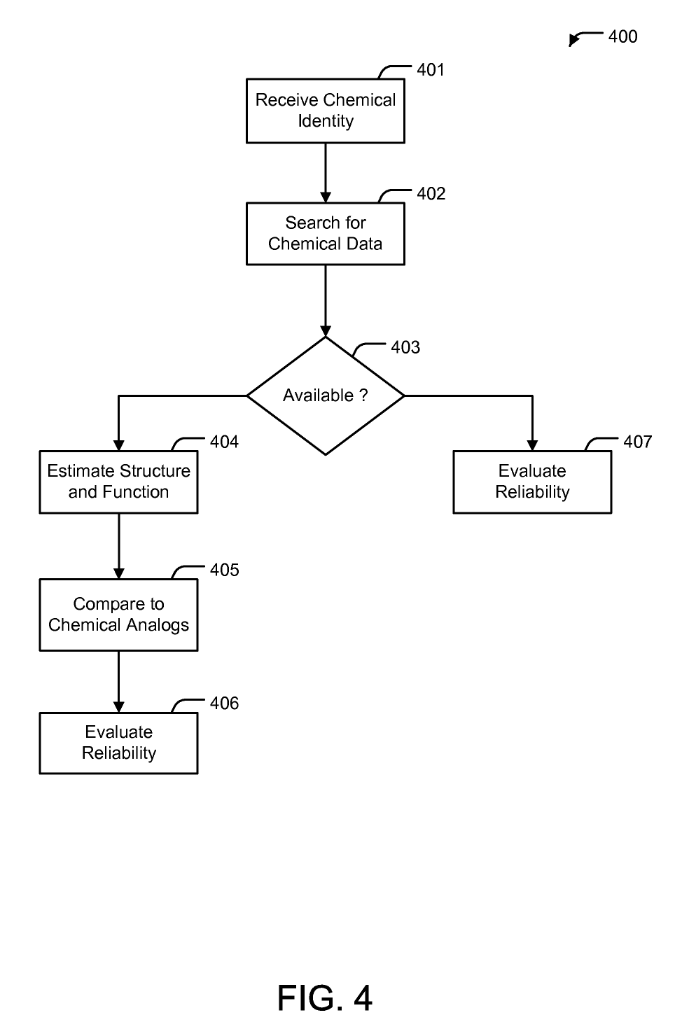

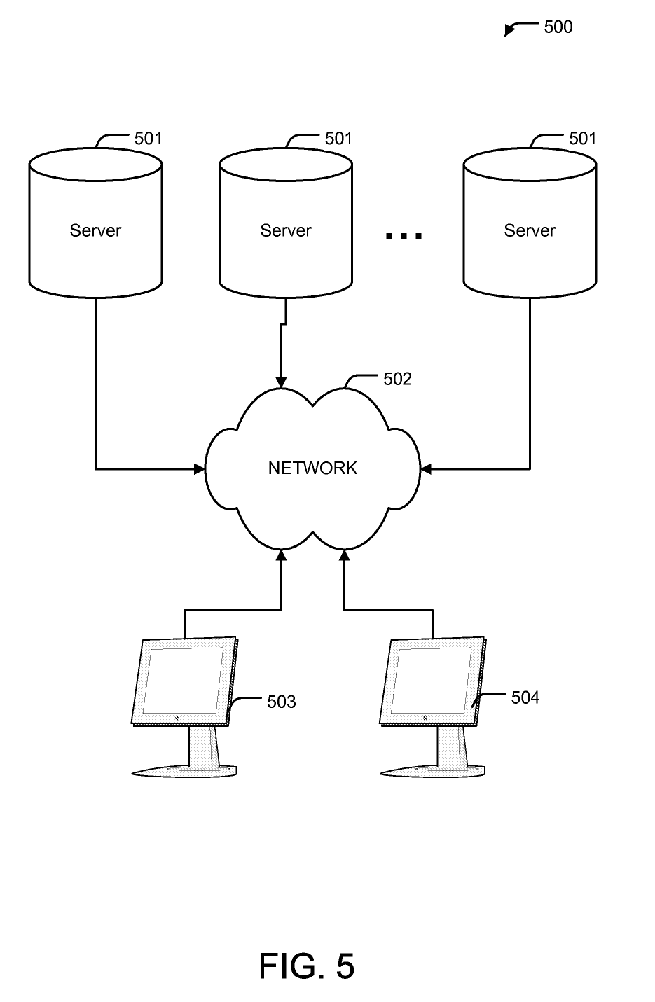

In response to the prioritizing, the method 200 includes determining if an appropriate replacement chemical exists within the prioritized list. For example, chemical efficacy determination is illustrated in FIG. 4. If a replacement chemical does exist, the method 200 includes providing/outputting replacement(s) information. If a replacement is not available, the method 200 further includes receiving modifications to chemical properties criteria from the originating search, and continuing with an additional search at block 201.

Turning now to FIG. 3, a more detailed method of mitigating environment, health, and safety issues in a chemical process using a candidate chemical is illustrated. The method 300 includes receiving a trial set of chemical properties criteria which provide a target chemical a desired efficacy for a chemical process at block 301. The chemical properties include physicochemical parameters and/or molecular structure attributes which are believed to provide the target chemical with its efficacy for a particular application, and may involve several alternative input sets.

The method 300 further includes identifying candidate replacement chemicals at block 302. The candidate replacement chemicals are identified through an automated and distributed search based upon whether the candidates possess combinations of physicochemical parameters and/or molecular structure attributes that fall within similar ranges to the target chemical. Different forms of searches may be combined and/or performed in parallel or sequentially to increase the efficacy of the search, with the results of these searches being ranked and or subsequently prioritized (305).

According to an example embodiment, the distributed search includes searching according to any suitable form, including those forms described in detail above with reference to FIG. 2.

Turning back to FIG. 3, the method 300 further includes prioritizing candidate replacement chemicals based on information related to each candidate replacement chemical's efficacy at block 303. The prioritizing may include sorting the distributed search results into a prioritized list based upon known efficacy properties.

In response to the prioritizing, the method 300 includes appending selected EHS properties by searching and abstracting the selected EHS data parameter values from multiple EHS data sources and/or by estimating the EHS properties by use of quantitative structure activity relationships (QSAR), and/or by estimating the properties via molecular simulation to the identified candidate replacement chemicals at block 304. This may include transforming and weighting of disparate EHS property parameter values to achieve a common relative scale of EHS hazard that accounts for differences in units of measure and differences in relative importance between EHS parameters, and which can be used to evaluate the overall magnitude of EHS hazard presented by a particular chemical.

Thereafter, the method 300 includes ranking and/or ordering the candidate chemicals according to their EHS properties so as to identify the least hazardous candidates based upon the inherent hazards of the chemicals at block 305.

Further, the method 300 includes re-ranking of the candidate chemicals according to the risk posed by the intended application at block 306. Additionally, available engineering controls for the intended application may be taken into consideration for re-ranking.

Thereafter, if a suitable number of results have been identified (307), the ranked list of results is provided at block 308. If not, or if more results are desired, the method 300 includes modifying the trial set of chemical properties at block 309 and subsequently repeating and/or iterating the method 300 with the modified properties.

The properties may be modified to increase or decrease values, omit or add new values, broaden the search to include other previously unconsidered chemicals, may be broadened to allow for increased EHS danger due to application of Engineering Controls during actual use of the replacement chemicals, or may be modified in any other suitable manner allowing for continuing iterations of the method 300 configured to produce or center upon a desired number of target replacement chemicals.

The desired number of target replacement chemicals may be achieved through further modification of parameters in a nested-iterative manner. For example, for each successive iteration of the method 300 or portions thereof, the relaxation of any of the above described parameters for prioritization may be established to determine if a set of candidate chemicals has increased accordingly.

The iteration may be achieved through multiple determinations of relative sizes of prioritized sets of candidate chemicals throughout processing of the method 300 by a computer device. For example, according to an example embodiment, the method 300 includes receiving the trial set of properties including physicochemical properties or molecular attributes that describes a function in a desired chemical process of a given chemical targeted for substitution, and performing the distributed multiple database search using objective similarity criteria based on the trial set of properties to identify a first set of candidate chemicals with physicochemical properties or molecular attributes related to the trial set of properties.

Example embodiments further include prioritizing the first set of candidate chemicals into a second set of candidate chemicals based on an efficacy of each chemical for the desired chemical process application and determining EHS data parameter values for each chemical of second set of candidate chemicals. Thereafter, disparate EHS data parameter values may be normalized into associated EHS properties for each chemical of the second set of candidate chemicals.

Thereafter, example embodiments include prioritizing the second set of candidate chemicals into a third set of candidate chemicals according to the associated EHS properties to identify the least hazardous candidate chemicals and prioritizing the third set of candidate chemicals into a fourth set of candidate chemicals according to the risk posed by the desired chemical process.

According to the iterative successions noted above, example embodiments may also include determining if the fourth set of candidate chemicals includes a minimum number of candidate chemicals, and, if the fourth set of candidate chemicals does not include the minimum number of candidate chemicals, iteratively relaxing the risk posed by the desired chemical process to increase a number of candidate chemicals in the fourth set of candidate chemicals.

Furthermore, example embodiments may include determining if the relaxed fourth set of candidate chemicals includes a minimum number of candidate chemicals, and, if the relaxed fourth set of candidate chemicals does not include the minimum number of candidate chemicals, iteratively relaxing the associated EHS properties to increase a number of candidate chemicals in the third set of candidate chemicals.

Furthermore, example embodiments may include determining if the relaxed third set of candidate chemicals includes a minimum number of candidate chemicals, and, if the relaxed third set of candidate chemicals does not include the minimum number of candidate chemicals, iteratively relaxing the prioritizing the efficacy of each chemical for the desired chemical process application to increase a number of candidate chemicals in the second set of candidate chemicals.

Moreover, example embodiments may include, determining if the relaxed second set of candidate chemicals includes a minimum number of candidate chemicals, and, if the relaxed second set of candidate chemicals does not include the minimum number of candidate chemicals, iteratively relaxing the trial set of properties to increase a number of candidate chemicals in the first set of candidate chemicals.

Therefore, as described above, the example embodiment illustrated in FIG. 3 may include iterative succession of any or all steps denoted therein such that a desired number of candidate chemicals is provided for verification or testing of reliability according to any desired chemical process for which a substitute chemical is being sought.

FIG. 4 illustrates a method of estimating the reliability of a chemical substitute (e.g., block 206 or 307) configured to mitigate environment, health, and safety issues in a chemical process, according to an example embodiment. The method 400 includes receiving a chemical identify at block 401. Upon receipt, the method 400 includes searching for available chemical data at block 403. If data appropriate to determining if a chemical performs well as a substitute is available, the method 400 includes evaluating the reliability of the chemical at block 407. Otherwise, the method 400 includes estimating the structure and function of the chemical at block 404, comparing the estimations to chemical analogs that may be available at block 405, and evaluating the reliability based on the estimating and comparing at block 406. As such, example embodiments provide methodologies for determining the reliability of a chemical in a process.

FIG. 5 illustrates a computing environment configured to mitigate the environment, health, and safety issues in a chemical process, according to an example embodiment.

As illustrated, the computing environment 500 includes a plurality of servers 501 in communication with network 502. The servers 501 may be any suitable servers, including computer devices hosting database access to information related to the structure and properties of chemicals. Each server may contain one or more databases, or any one database may be distributed across a plurality of servers. The network 502 may be any suitable network, including the Internet, Wide Area Network, Local Area Network, and/or any combination of network configured to allow transmission and receipt of requests and responses regarding distributed database searches across nodes/servers/devices in communication with the network 502.

Turning back to FIG. 5, the computing environment 500 further includes terminals 503 and 504 in communication with the network 502. Terminals 503 and 504 may be user-accessible terminals suitable for performing distributed searches and analysis as described herein. The terminals 503 and 504 may be apparatuses populated by convention computer apparatus components including host processors, memory, computer readable storage mediums, display means, and any other appropriate components. Thus, any or both of terminals 503 and 504 may be configured to process computer-executable instructions that direct host processors of the terminals to perform any of the methods described above. Although particularly illustrated as including specific numbers of components and devices, it is readily understood that the computing environment 500 is extensible to virtually any implementation allowing for the communication of databased information a network.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are examples only. There may be many variations these diagrams and steps (or operations) described therein without departing from the spirit of the invention. For instance, the steps may be performed in a differing order or steps may be added, deleted or modified. All of these variations are considered a part of the claimed invention.

While only example embodiments have been described, it will be understood that those skilled in the art, both now and in the future, may make various improvements and enhancements which fall within the scope of the claims which follow. These claims should be construed to maintain the proper protection for the invention first described.

What is claimed is:

1. A method of identifying a substitute chemical, comprising:
receiving, at a computer, a trial set of properties including physicochemical properties or molecular attributes that describes a function in a desired chemical process of a given chemical targeted for substitution;
performing a distributed multiple database search using objective similarity criteria based on the trial set of properties to identify a first set of candidate chemicals with physicochemical properties or molecular attributes related to the trial set of properties;
prioritizing the first set of candidate chemicals into a second set of candidate chemicals based on an efficacy of each chemical for the desired chemical process application;
determining Environmental, Health, and Safety (EHS) data parameter values for each chemical of the second set of candidate chemicals;
normalizing disparate EHS data parameter values into associated EHS properties for each chemical of the second set of candidate chemicals;
prioritizing the second set of candidate chemicals into a third set of candidate chemicals according to the associated EHS properties to identify the least hazardous candidate chemicals; and
prioritizing the third set of candidate chemicals into a fourth set of candidate chemicals according to the risk posed by the desired chemical process.

2. The method of claim 1, further comprising:
determining if the fourth set of candidate chemicals includes a minimum number of candidate chemicals; and
if the fourth set of candidate chemicals does not include the minimum number of candidate chemicals, iteratively relaxing the risk posed by the desired chemical process to increase a number of candidate chemicals in the fourth set of candidate chemicals.

3. The method of claim 2, further comprising:
determining if the relaxed fourth set of candidate chemicals includes a minimum number of candidate chemicals; and
if the relaxed fourth set of candidate chemicals does not include the minimum number of candidate chemicals, iteratively relaxing the associated EHS properties to increase a number of candidate chemicals in the third set of candidate chemicals.

4. The method of claim 3, further comprising:
determining if the relaxed third set of candidate chemicals includes a minimum number of candidate chemicals; and
if the relaxed third set of candidate chemicals does not include the minimum number of candidate chemicals, iteratively relaxing the prioritizing the efficacy of each chemical for the desired chemical process application to increase a number of candidate chemicals in the second set of candidate chemicals.

5. The method of claim 4, further comprising:
determining if the relaxed second set of candidate chemicals includes a minimum number of candidate chemicals; and
if the relaxed second set of candidate chemicals does not include the minimum number of candidate chemicals, iteratively relaxing the trial set of properties to increase a number of candidate chemicals in the first set of candidate chemicals.

6. The method of claim 1, wherein the performing a distributed multiple database search comprises performing a distributed search across a set of chemical databases available to the computer, wherein the distributed search includes searching the chemical databases for chemicals with properties laying within boundaries of a desired numerical range.

7. The method of claim 1, wherein the performing a distributed multiple database search comprises performing a distributed search across a set of chemical databases available to the computer, wherein the distributed search excludes chemicals which contain particular chemical elements.

8. The method of claim 1, wherein the performing a distributed multiple database search comprises performing a distributed search across a set of chemical databases available to the computer, wherein the distributed search excludes chemicals which contain a combination of particular chemical elements.

9. The method of claim 1, wherein the performing a distributed multiple database search comprises performing a distributed search across a set of chemical databases available to the computer, wherein the distributed search includes identifying chemicals with properties extending beyond a maximum numerical boundary.

10. The method of claim 1, wherein the performing a distributed multiple database search comprises performing a distributed search across a set of chemical databases available to the computer, wherein the distributed search includes identifying chemicals with properties extending below a minimum numerical boundary.

11. The method of claim 1, wherein the performing a distributed multiple database search comprises performing a distributed search across a set of chemical databases available to the computer, wherein the distributed search excludes database items which lack information about a particular chemical property.

12. The method of claim 1, wherein the performing a distributed multiple database search comprises performing a distributed search across a set of chemical databases available to the computer, wherein the distributed search includes identifying chemical results based upon the minimization of an objective function that provides a measure of the difference between target values of the set of chemical properties and chemical properties of database chemicals.

13. The method of claim 1, wherein the performing a distributed multiple database search comprises performing a distributed search across a set of chemical databases available to the computer, wherein the distributed search includes considering an objective function value.

14. The method of claim 1, wherein the performing a distributed multiple database search comprises performing a distributed search across a set of chemical databases available to the computer, wherein the distributed search includes identifying chemical results based upon the minimization of an objective function that provides a measure of the difference between target values of the set of chemical properties and chemical properties of database chemicals.

15. The method of claim 1, wherein the performing a distributed multiple database search comprises performing a distributed search across a set of chemical databases available to the computer, wherein the distributed search includes searching for particular functional groups within chemicals.

16. The method of claim 1, further comprising determining if an appropriate replacement chemical exists within the fourth set of candidate chemicals by:
identifying chemical data for a candidate chemical of a prioritized list;
estimating structure and function of the candidate chemical based upon the chemical data; and
evaluating reliability of the candidate chemical in performing the desired chemical process based upon the estimation.

17. The method of claim 1, further comprising determining if an appropriate replacement chemical exists within the fourth set of candidate chemicals by:
identifying chemical data for a candidate chemical of the prioritized list;
comparing the candidate chemical to known chemical analogs based upon the chemical data; and
evaluating reliability of the candidate chemical in performing the desired chemical process based upon the comparison.

18. A system for identifying a substitute chemical, comprising:
a plurality of chemical databases, wherein each chemical database is configured to store information related to the molecular and physical properties of a plurality of chemicals; and
a computer apparatus in operative communication with the plurality of chemical databases, wherein the computer apparatus is configured to execute computer executable instructions that direct the computer apparatus to perform a method, comprising:
receiving, at the computer, a set of chemical properties of a chemical to be replaced;
identifying candidate substitute chemicals within the plurality of chemical databases based upon similarities between the set of chemical properties and chemical properties of each candidate substitute chemical considered;
evaluating environmental impact characteristics and human health impact characteristics of the candidate substitute chemicals;
prioritizing the candidate replacement chemicals based on the environmental impact characteristics and the human health impact characteristics of each candidate replacement chemical; and
determining if an appropriate replacement chemical exists within the prioritized candidate replacement chemicals.

19. The system of claim 18, wherein the method further comprises outputting a description of the appropriate chemical in response to the determining.

20. The system of claim 18, wherein the identifying candidate substitute chemicals comprises performing a distributed search across the plurality of chemical databases, wherein the distributed search includes at least one of:
searching the chemical databases for chemicals with properties lying within boundaries of a desired numerical range;
searching the chemical databases for chemicals with properties extending beyond a maximum numerical boundary;
searching the chemical databases for chemicals with properties extending below a minimum numerical boundary; and
identifying chemical results based upon the minimization or maximization of an objective function that provides a measure of the difference between target values of the set of chemical properties and chemical properties of candidate replacement chemicals.

21. The system of claim 18, wherein the identifying candidate substitute chemicals comprises performing a distributed search across a set of chemical databases available to the computer, wherein the distributed search excludes:
chemicals which contain particular chemical elements;
chemicals which contain a combination of particular chemical elements; and
database items which lack information about a particular chemical property.

22. A computer program product including a non-transitory computer readable storage medium having computer-executable instructions stored thereon that, when executed by a processor of a computer apparatus, direct the processor to perform a method, comprising:
receiving a trial set of properties including physicochemical properties or molecular attributes that describes a function in a desired chemical process of a given chemical targeted for substitution;
performing a distributed multiple database search using objective similarity criteria based on the trial set of properties to identify a first set of candidate chemicals with physicochemical properties or molecular attributes related to the trial set of properties;
prioritizing the first set of candidate chemicals into a second set of candidate chemicals based on an efficacy of each chemical for the desired chemical process application;
determining Environmental, Health, and Safety (EHS) data parameter values for each chemical of the second set of candidate chemicals;
normalizing disparate EHS data parameter values into associated EHS properties for each chemical of the second set of candidate chemicals;
prioritizing the second set of candidate chemicals into a third set of candidate chemicals according to the associated EHS properties to identify the least hazardous candidate chemicals; and
prioritizing the third set of candidate chemicals into a fourth set of candidate chemicals according to the risk posed by the desired chemical process.
